(19) United States
(12) Patent Application Publication
(10) Pub. No.: US 2008/0175262 A1
(43) Pub. Date: Jul. 24, 2008

(54) DATA COMMUNICATION APPARATUS, CONFIGURATION INFORMATION UPDATE METHOD, AND CONFIGURATION INFORMATION UPDATE PROGRAM

(75) Inventors: Hiroshi KAWANO, Fukuoka (JP); Kenichi Ohyama, Fukuoka (JP); Katsuyuki Okabe, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/013,830

(22) Filed: Jan. 14, 2008

(30) Foreign Application Priority Data
Jan. 19, 2007 (JP) 2007-10190

(51) Int. Cl. H04L 12/54

(52) U.S. Cl. 370/428

(57) ABSTRACT

A data communication apparatus stores each data received via a network and transfers each data in accordance with destination addresses of each data. The data communication apparatus includes a stop-control information generator, which upon updating of circuit configuration information of a programmable logic circuit provided in the data communication apparatus is performed, generates stop-control information stopping data transmitted from an external data communication apparatus from entering the programmable logic circuit.

### CROSS-REFERENCE TO RELATED APPLICATIONS

This application is related to and claims priority to Japanese patent application no. 2007-10190 filed on Jan. 19.2007 in the Japan Patent Office, and incorporated by reference herein.

### TECHNICAL FIELD

The embodiments relate to a data communication apparatus that stores each data received via a network and that transfers each data in accordance with destination addresses of each data, for example, in the order in which each data were stored, to a configuration information update method for updating circuit configuration information of a programmable logic circuit provided in a data communication apparatus, and to a configuration information update program for causing a computer to perform a method for updating circuit configuration information of a programmable logic circuit provided in a data communication apparatus.

### SUMMARY

According to an aspect of an embodiment, a data communication apparatus stores each data received via a network and transfers each data in accordance with destination addresses of each data, for example, in the order in which each data were stored.

The data communication apparatus includes a stop-control information generator, when updating of circuit configuration information of a programmable logic circuit provided in the data communication apparatus is performed, generate stop-control information for performing stop control such that data transmitted from an external data communication apparatus does not enter the programmable logic circuit.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a functional block diagram of a data communication apparatus according to a first embodiment;

FIG. 2 is a functional block and data flow diagram of a data communication apparatus using a flow controller, according to an embodiment;

FIG. 3 is a functional block and data flow diagram of the data communication apparatus and processing thereof according to the first embodiment;

FIG. 4 is a functional block diagram of a data communication apparatus according to a second embodiment;

FIG. 5 is a functional block and data flow diagram of the data communication apparatus and processing thereof according to the second embodiment;

FIG. 6 is a functional block diagram of a data communication apparatus, according to a third embodiment;

FIG. 7 is a functional block and a data flow diagram of the data communication apparatus and processing thereof, according to the third embodiment;

FIG. 8 is a functional block diagram of a data communication apparatus, according to a fourth embodiment;

FIG. 9 is a functional block and a data flow diagram of the data communication apparatus and processing thereof, according to the fourth embodiment;

FIG. 10 is a functional block diagram of a data communication apparatus, according to a fifth embodiment;

FIG. 11 is a functional block and a data flow diagram of the data communication apparatus and processing thereof, according to the fifth embodiment; and

FIG. 12 is a functional block diagram of a computer that performs (executes) a configuration information update program, according to an embodiment.

### DETAILED DESCRIPTION OF THE PREFERRED EMBODIMENTS

A technology for updating configuration data of a programmable logic circuit (that is, a hardware circuit that can be reconfigured by rewriting as if it is software), such as a field programmable gate array (FPGA), a programmable logic device (PLD), or the like provided in a communication apparatus or a transmission apparatus, such as a router, is available. Normally, when updating of configuration data of a programmable logic circuit is required due to a change in the specifications of the programmable logic circuit or a defect in the programmable logic circuit, a service to an end user (for example, a service, such as the Internet, used with a terminal apparatus or the like) is stopped and the configuration data is then updated.

In addition, a technology is available in which, due to the provision of a programmable logic circuit having a so-called redundant configuration, processing can be continued even if the programmable logic circuit includes a logic cell requiring reconfiguration. More specifically, divided clock lines for supplying clock signals for causing logic cells forming a programmable logic circuit to execute processing are prepared, and only a clock signal to be supplied to a logic cell requiring reconfiguration is stopped. Accordingly, processing of the other logic cells not requiring reconfiguration can be continued.

However, this technology has a problem in that in order to update configuration data of a programmable logic circuit, a service to an end user must be stopped. That is, since user data that is received from a terminal apparatus used by the end user and that is stored in a buffer is disposed of when the configuration data is updated, a service to the end user must be completely stopped when updating of the configuration data is performed.

In addition, in this technology, it is necessary to provide a programmable logic circuit having a redundant configuration. Thus, the circuit scale of the programmable logic circuit increases.

The embodiments provide a data communication apparatus, a configuration information update method, and a configuration information update program that are capable of updating configuration data without stopping a service to an end user.

Data communication apparatuses, configuration information update methods, and configuration information update programs according to embodiments is described with reference to the drawings. First, a data communication apparatus according to a first embodiment is described. Then, other embodiments is described.

An outline and features of the data communication apparatus according to the first embodiment and a configuration and processing of the data communication apparatus according to the first embodiment is described in that order, and then advantages of the first embodiment is described. In the description of the data communication apparatus according to the first embodiment, for example, a case where half-duplex communication is performed between routers is described.

### Outline and Features of Data Communication Apparatus

### First Embodiment

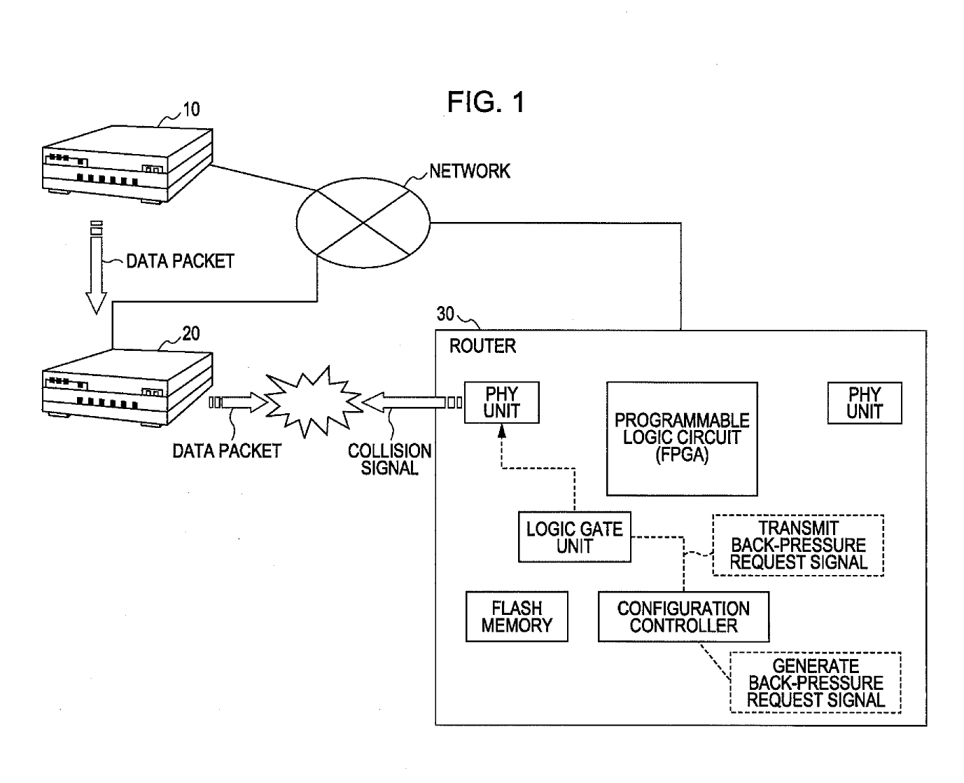

An outline and features of the data communication apparatus according to the first embodiment is described with reference to FIG. 1. FIG. 1 illustrates the outline and features of the data communication apparatus according to the first embodiment.

An outline of the data communication apparatus according to the first embodiment is that the data communication apparatus stores each data received via a network and transfers each data in accordance with destination addresses of each data, for example (but not limited to) in the order in which each data were stored. A main feature of the data communication apparatus according to the first embodiment is that the data communication apparatus is capable of updating configuration data of a programmable logic circuit without stopping a service to an end user.

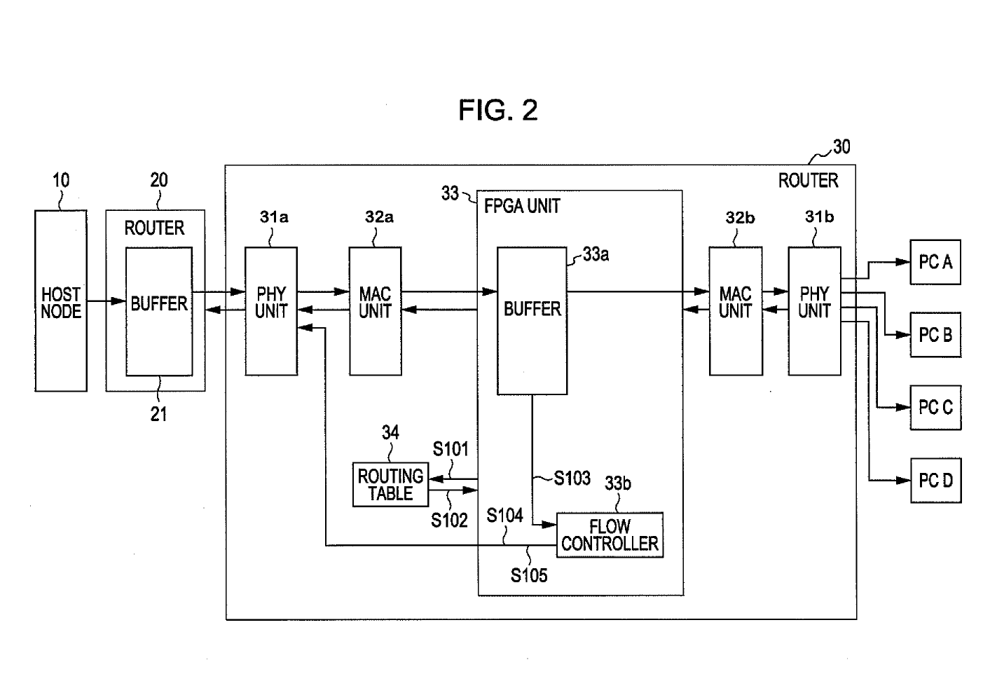

Operations of the data communication apparatus according to the first embodiment in a case where half-duplex communication is performed between routers in a normal operation state using a flow controller is described with reference to FIG. 2. As shown in FIG. 2, a router 20 receives a data packet from a host node 10 via a network, and transfers the data packet, for example, to a router 30 in accordance with a destination address of the data packet.

The router 30 receives the packet from the router 20, and performs the operations described below in the normal operation state. In FIG. 2, a router might include a physical layer (PHY) unit 31 and/or a media access control (MAC) unit 32 for data reception and/or transfer, or the router might includes a plurality of physical layers (PHY) units 31a-n and/or media access control (MAC) units 32a-n. As shown in FIG. 2, a physical layer (PHY) unit 31a of the router 30 receives the data packet from the router 20 and performs conversion from a digital signal into data, and a media access control (MAC) unit 32a of the router 30 decapsulates the encapsulated data and transmits to an FPGA unit 33 data including user data and a destination address.

The FPGA unit 33, which is a programmable logic circuit, receives the data including the user data and the destination address from the MAC unit 32a, and requests a routing table 34 to compare the destination address of the user data with information stored in the routing table 34 (S101). The FPGA unit 33 stores each data received from the MAC unit 32a into a buffer 33a and processes each data in the order in which each data were stored.

In response to the request from the FPGA unit 33, the routing table 34 notifies the FPGA unit 33 of information on an interface connected to a destination node (S102). The FPGA unit 33 determines a destination interface in accordance with the notification received from the routing table 34, and transmits information on the destination interface and the user data to the MAC unit 32b. The MAC unit 32b generates transmission data (a data packet) in accordance with the information on the destination interface and the user data received from the FPGA unit 33 and transmits the generated transmission data to the PHY unit 31b. The PHY unit 31b converts the data received from the MAC unit 32 into a digital signal and transmits the digital signal.

As described above, each data received from the MAC unit 32a are stored in the buffer 33a. Since there is a limitation in the amount of data that can be stored in the buffer 33a, a flow controller 33b of the FPGA unit 33 monitors the amount of data storage and controls the amount of data stored in the buffer 33a not to exceed a predetermined threshold (upper limit) and not to fall below a predetermined threshold (lower limit) (S103). If the amount of data stored in the buffer 33a exceeds the upper limit, the flow controller 33b transmits to the PHY unit 31a a back-pressure request signal for temporarily stopping the transmission of data from the router 20 (104). The PHY unit 31a receives the back-pressure request signal, and transmits a collision signal to the router 20. The router 20 detects the collision signal transmitted from the router 30, and temporarily stops the transmission of data to the router 30.

While the transmission of data from the router 20 is stopped, the FPGA unit 33 of the router 30 processes remaining data stored in the buffer 33a and transmits the processed data to lower-order nodes (for example, personal computers (PCs) A to D). If the amount of data stored in the buffer 33a falls below the lower limit, the flow controller 33b transmits to the PHY unit 31a a back-pressure-release request signal for resuming the transmission of data from the router 20 (S105). The PHY unit 31a receives the back-pressure-release request signal, and transmits a release signal to the router 20. The router 20 detects the release signal transmitted from the router 30, and resumes the transmission of data to the router 30.

As described above, the data communication apparatus (router) according to the first embodiment performs the above-described operations in the normal operation state A case where updating of configuration data of the FPGA unit 33 is performed, which relates to the main feature of the data communication apparatus (router), is described next.

As shown in FIG. 1, in the case of updating configuration data of the programmable logic circuit (FPGA), the configuration controller of the router 30 generates a back-pressure request signal for temporarily stopping the transmission of data from the router 20 and transmits the generated back-pressure request signal to a logic gate unit. The logic gate unit receives the back-pressure request signal transmitted from the configuration controller and transmits the received back-pressure request signal to the PHY unit. In order to handle the normal operation state as well as updating of configuration data, when receiving a back-pressure request signal from at least one of the configuration controller or the flow controller 33b, the logic gate unit transmits the received back-pressure request signal to the PHY unit.

The PHY unit 31a receives the back-pressure request signal from the configuration controller, and transmits a collision signal to the router 20, as in the normal operation state described above. The router 20 detects the collision signal transmitted from the router 30, and temporarily stops the transmission of data to the router 30. While temporarily stopping the transmission of data to the router 30, the router 20 stores data packets transmitted from the host node 10 into a buffer 21 contained in the router 20.

While the transmission of data from the router 20 is stopped, the configuration controller transmits all the data stored in the buffer of the programmable logic circuit (FPGA). Then, the configuration controller reads updated configuration data from a flash memory, and transmits the read configuration data to the programmable logic circuit (FPGA).

When transfer of the configuration data is completed, the configuration controller transmits to the PHY unit 31a a back-pressure-release request signal for resuming the transmission of data from the router 20, as in the normal operation state described above. The PHY unit 31a receives the back-pressure-release request signal, and releases the collision signal, which has been transmitted to the router 20. When the collision signal transmitted from the router 30 is released, the router 20 resumes the transmission of data to the router 30.

Accordingly, the data communication apparatus according to the first embodiment is capable of updating configuration data of a programmable logic circuit without stopping a service to an end user.

### Configuration and Processing of Data Communication Apparatus

### First Embodiment

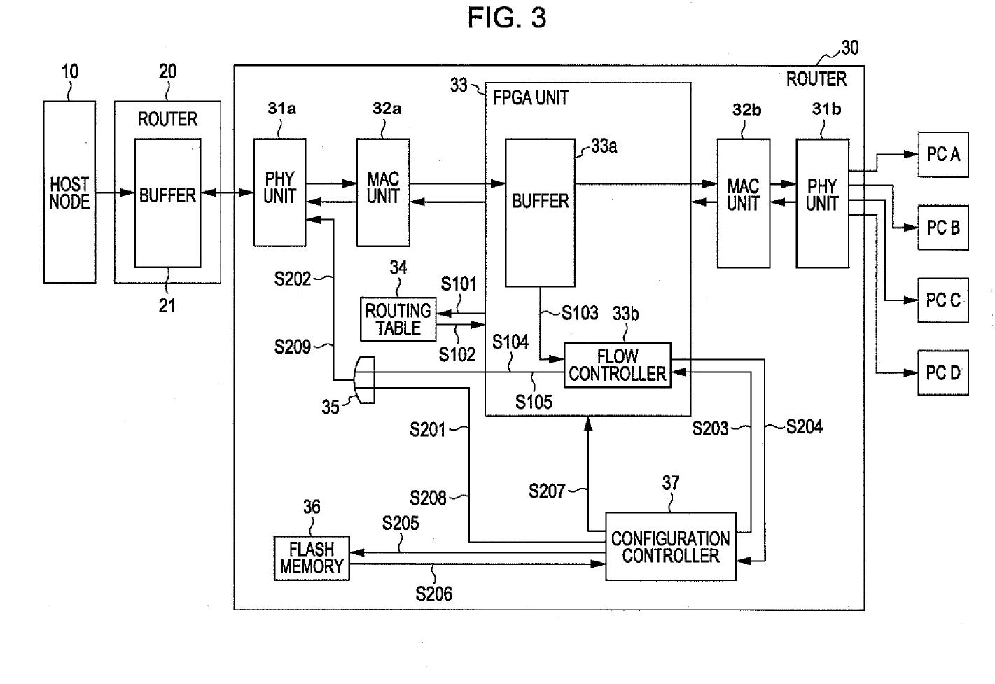

A configuration and processing of the data communication apparatus according to the first embodiment is described with reference to FIG. 3. FIG. 3 illustrates the configuration and processing of the data communication apparatus according to the first embodiment. As an example of the data communication apparatus according to the first embodiment, a router that performs half-duplex communication is described.

Referring to the FIG. 3, the router 30, which is the data communication apparatus according to the first embodiment, includes the PHY unit 31a, the PHY unit 31b, the MAC unit 32a, the MAC unit 32b, the routing table 34, a logic gate unit 35, a flash memory 36, and a configuration controller 37.

The PHY unit 31a receives a data packet from the router 20 and performs conversion from a digital signal into data. Then, the PHY unit 31a transmits the data to the MAC unit 32a. When receiving a back-pressure request signal from the logic gate unit 35, the PHY unit 31a transmits a collision signal to the router 20. In contrast, when receiving a back-pressure-release request signal from the logic gate unit 35, the PHY unit 31a releases a collision signal that has been transmitted to the router 20. The MAC unit 32a decapsulates encapsulated data received from the PHY unit 31a, and transmits to the FPGA unit 33 data including user data and a destination address.

The FPGA unit 33 is a hardware programmable logic circuit that can be reconfigured by rewriting as if it is software. The FPGA unit 33 includes the buffer 33a and the flow controller 33b, which are related to an aspect of the embodiments.

The buffer 33a receives from the MAC unit 32a data including user data and a destination address, and stores the received data.

The flow controller 33b monitors the amount of data storage and controls the amount of data stored in the buffer 33a not to exceed a predetermined threshold (upper limit) and not to fall below a predetermined threshold (lower limit). More specifically, if the amount of data stored in the buffer 33a exceeds the upper limit, the flow controller 33b transmits to the logic gate unit 35 a back-pressure request signal for temporarily stopping the transmission of data from the router 20. In contrast, if the amount of data stored in the buffer 33a falls below the lower limit, the flow controller 33b transmits to the logic gate unit 35 a back-pressure-release request signal for resuming the transmission of data from the router 20.

When the flow controller 33b receives a request for transmission of all the data stored in the buffer 33a of the FPGA unit 33 (a request for setting of the lower limit of the buffer threshold for the buffer 33a to “0”) from the configuration controller 37, all the data stored in the buffer 33a is transmitted. Then, the flow controller 33b transmits to the configuration controller 37 notification (“buffer empty notification”) indicating that all the data stored in the buffer 33a has been transmitted and the buffer 33a is now empty.

In the normal operation state, the FPGA unit 33 performs normal routing processing. More specifically, when receiving from the MAC unit 32a data including user data and a destination address, the FPGA unit 33 requests the routing table 34 to compare the destination address of the user data with information stored in the routing table 34. Then, the FPGA unit 33 determines a destination interface in accordance with notification transmitted from the routing table 34, and transmits information on the destination interface and the user data to the MAC unit 32b.

The routing table 34 transmits, in response to a request from the FPGA unit 33, information on an interface connected to a destination node.

The logic gate unit 35 transmits to the PHY unit 31a a back-pressure request signal received from the flow controller 33b or the configuration controller 37. More specifically, the logic gate unit 35 performs a logical OR of back-pressure requests from the configuration controller 37 and the flow controller 33b. When receiving a back-pressure request signal from at least one of the configuration controller 37 or the flow controller 33b, the logic gate unit 35 transmits the back-pressure request signal to the PHY unit 31a. The logic gate unit 35 performs a logical OR of back-pressure requests from the configuration controller 37 and the flow controller 33b so as to handle the normal operation state as well as a state where updating of configuration data in the FPGA unit 33 is performed.

As in the case of a back-pressure request signal, the logic gate unit 35 performs a logical OR of back-pressure-release requests from the configuration controller 37 and the flow controller 33b. When receiving a back-pressure-release request signal from at least one of the configuration controller 37 or the flow controller 33b, the logic gate unit 35 transmits the back-pressure-release request signal to the PHY unit 31a.

The flash memory 36 stores in advance updated configuration data.

The configuration controller 37 controls updating of configuration data (circuit configuration information) in the FPGA unit 33. More specifically, in the case of updating configuration data of the FPGA unit 33, the configuration controller 37 transmits to the logic gate unit 35 a back-pressure request signal for temporarily stopping the transmission of data from the router 20.

While transmission of data from the router 20 is stopped, the configuration controller 37 requests the flow controller 33b to transmit all the data stored in the buffer 33a of the FPGA unit 33 (to set the lower limit of the buffer threshold for the buffer 33a to “0”). When receiving from the flow controller 33b notification (“buffer empty notification”) indicating that all the data stored in the buffer 33a has been transmitted and the buffer 33a is now empty, the configuration controller 37 reads updated configuration data from the flash memory 36 and transfers the read configuration data to the FPGA unit 33.

After transfer of the configuration data is completed, the configuration controller 37 transmits to the logic gate unit 35 a back-pressure-release request signal for resuming the transmission of data from the router 20.

While transmission of data to the router 30 is temporarily stopped, the router 20 stores data packets transmitted from the host node 10 into the buffer 21 contained in the router 20.

The processing of the data communication apparatus according to the first embodiment is described with reference to FIG. 3. Since processing of operations S101 to S105 shown in FIG. 3 is similar to the processing of operations S101 to S105 shown in FIG. 2, only processing of operations S201 to S209 is described.

Referring to FIG. 3, in the case of updating configuration data of the FPGA unit 33, the configuration controller 37 transmits to the logic gate unit 35 a back-pressure request signal for temporarily stopping the transmission of data from the router 20 (S201).

The logic gate unit 35 transmits to the PHY unit 31a the back-pressure request signal received from the configuration controller 37 (S202). More specifically, the logic gate unit 35 performs a logical OR of back-pressure requests from the configuration controller 37 and the flow controller 33b. When receiving a back-pressure request signal from at least one of the configuration controller 37 or the flow controller 33b, the logic gate unit 35 transmits the back-pressure request signal to the PHY unit 31a.

When receiving the back-pressure request signal from the logic gate unit 35, the PHY unit 31a transmits a collision signal to the router 20. When detecting the collision signal transmitted from the router 30, the router 20 temporarily stops the transmission of data to the router 30.

While transmission of data from the router 20 is stopped, the configuration controller 37 requests the flow controller 33b to transmit all the data stored in the buffer 33a of the FPGA unit 33 (to set the lower limit of the buffer threshold for the buffer 33a to “0”) (S203).

The configuration controller 37 receives from the flow controller 33b notification (“buffer empty notification”) indicating that all the data stored in the buffer 33a has been transmitted and the buffer 33a is now empty (S204). Then, the configuration controller 37 requests reading of updated configuration data from the flash memory 36 (S205), reads the configuration data from the flash memory 36 (S206), and transfers the read configuration data to the FPGA unit 33 (S207).

After transfer of the configuration data is completed, the configuration controller 37 transmits to the logic gate unit 35 a back-pressure-release request signal for resuming the transmission of data from the router 20 (S208). When receiving the back-pressure-release request signal from the configuration controller 37, the logic gate unit 35 transmits the back-pressure-release request signal to the PHY unit 31a (S209).

The PHY unit 31a receives the back-pressure-release request signal, and releases the collision signal that has been transmitted to the router 20. When the collision signal transmitted from the router 30 is released, the router 20 resumes the transmission of data to the router 30, the data being stored in the buffer 21 while transmission of data to the router 30 was temporarily stopped.

### Advantages of First Embodiment

As described above, according to the first embodiment, in the case of updating circuit configuration information (configuration data) of an FPGA, which is a programmable logic circuit, stop-control information (for example, a back-pressure request signal) for performing stop control such that data transmitted from an external data communication apparatus (for example, the router 20) does not enter the FPGA unit 33 is generated. Thus, while stop control is performed such that data packets received from an end user do not enter a programmable logic circuit (for example, while data packets are stored into the buffer 21 of the router 20), the configuration data can be updated without stopping a service to the end user.

According to the first embodiment, a data communication apparatus includes a collision-signal transmitter (for example, the PHY unit 31a) that transmits to an external data communication apparatus (for example, the router 20) a collision signal for temporarily stopping the transmission of data from the external data communication apparatus (for example, the router 20). In addition, a back-pressure request signal for requesting transmission of a collision signal is generated as stop-control information by the configuration controller 37 and/or the flow controller 33b and is transmitted to the collision-signal transmitter (for example, the PHY unit 31a). Thus, when half-duplex communication is performed between the data communication apparatus and the external data communication apparatus (for example, between the router 30 and the router 20), transmission of data from the external data communication apparatus (for example, the router 20) can be temporarily stopped while functions (a back-pressure request signal generation function and a back-pressure request signal transmission function) can be achieved. Furthermore, even if transmission of data from the external data communication apparatus (for example, the router 20) is temporarily stopped, data transmitted from an end user can be temporarily saved in the external data communication apparatus (for example, the buffer 21 of the router 20). Thus, configuration data can be updated without stopping a service to the end user.

### Second Embodiment

In the first embodiment, with the use of a back-pressure request signal used in a case where half-duplex communication is performed between routers (a data communication apparatus and an external data communication apparatus), transmission of data from the external data communication apparatus is temporarily stopped, and configuration data of the FPGA unit 33 is updated. However, the present invention is not limited to this. With the use of a pause-frame request signal used in a case where full-duplex communication is performed between routers, configuration data of the FPGA unit 33 may be updated. Hereinafter, an outline and features of a data communication apparatus according to a second embodiment and a configuration and processing of the data communication apparatus according to the second embodiment is described in that order, and then advantages of the second embodiment is described. In the description of the data communication apparatus according to the second embodiment, for example, a case where full-duplex communication is performed between routers is described.

Similarly to the data communication apparatus according to the first embodiment, an outline of the data communication apparatus according to the second embodiment is that the data communication apparatus stores each data received via a network and transfers each data in accordance with destination addresses of each data in the order in which each data were stored. A main feature of the data communication apparatus according to the second embodiment is that the data communication apparatus is capable of updating configuration data of a programmable logic circuit without stopping a service to an end user by using a pause-frame request signal.

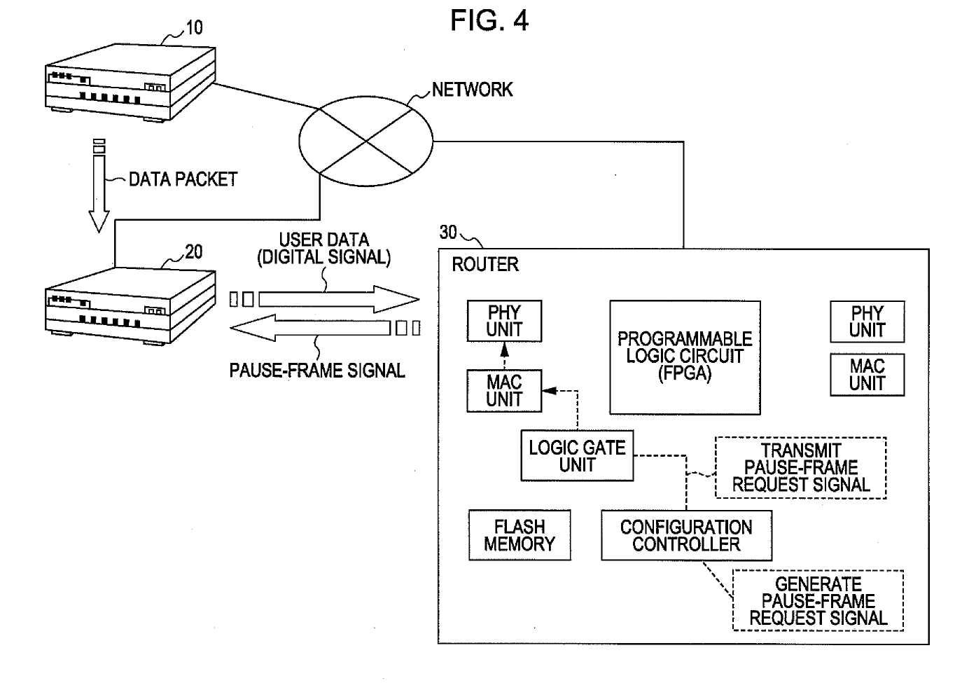

That is, as shown in FIG. 4, in the case of updating configuration data of the programmable logic circuit (FPGA), the configuration controller of the router 30 generates a pause-frame request signal for temporarily stopping the transmission of data (a data packet) from the router 20 and transmits the generated pause-frame request signal to the logic gate unit. The logic gate unit receives the pause-frame request signal transmitted from the configuration controller, and transmits the received pause-frame request signal to the MAC unit. In order to handle the normal operation state as well as updating of configuration data, when receiving a pause-frame request signal from at least one of the configuration controller or the flow controller 33b (see FIG. 2), the logic gate unit transmits the pause-frame request signal to the MAC unit.

When receiving the pause-frame request signal from the configuration controller, the MAC unit generates a pause frame and transmits the generated pause frame to the PHY unit. When receiving the pause frame from the MAC unit, the PHY unit converts the pause frame into a digital signal and transmits the digital signal as a pause-frame signal to the router 20.

The router 20 analyzes the pause-frame signal received from the router 30, and temporarily stops the transmission of data to the router 30. While transmission of data to the router 30 is temporarily stopped, the router 20 stores data transmitted from the host node 10 into a buffer contained in the router 20.

After transfer of the configuration data to the programmable logic circuit (FPGA) is completed, the configuration controller transmits to the MAC unit a pause-frame-release request signal for resuming the transmission of data from the router 20. The MAC unit receives the pause-frame-release request signal from the configuration controller, and generates a release frame and transmits the generated release frame to the PHY unit. The PHY unit receives the release frame from the MAC unit, and converts the release frame into a digital signal. The MAC unit transmits the digital signal as a release signal to the router 20.

The router 20 analyzes the release signal received from the router 30, and resumes the transmission of data to the router 30. Since the other operations of the data communication apparatus according to the second embodiment are similar to those of the data communication apparatus according to the first embodiment, the description of those operations is omitted.

Accordingly, the data communication apparatus according to the second embodiment is capable of updating configuration data of a programmable logic circuit by using a pause-frame request signal without stopping a service to an end user.

### Configuration and Processing of Data Communication Apparatus

### Second Embodiment

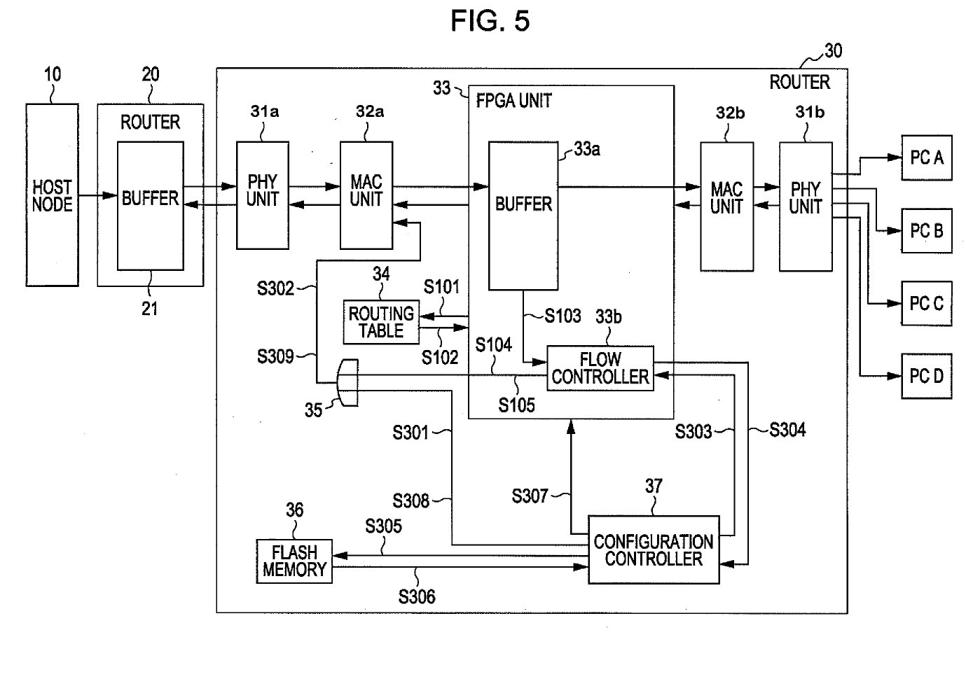

The configuration and processing of the data communication apparatus according to the second embodiment is described with reference to FIG. 5. FIG. 5 illustrates the configuration and processing of the data communication apparatus according to the second embodiment.

In the data communication apparatus according to the second embodiment, the configurations (processing functions) of the FPGA unit 33, the routing table 34, and the flash memory 36 are similar to those of the data communication apparatus according to the first embodiment shown in FIG. 3. However, the data communication apparatus according to the second embodiment is different from the data communication apparatus according to the first embodiment in the points described below.

That is, when receiving a pause frame from the MAC unit, the PHY unit 31a converts the pause frame into a digital signal and transmits the digital signal as a pause-frame signal to the router 20. When receiving a release frame from the MAC unit 32a, the PHY unit 31a converts the release frame into a digital signal and transmits the digital signal as a release signal to the router 20.

When receiving a pause-frame request signal from the logic gate unit 35, the MAC unit 32a generates a pause frame and transmits the generated pause frame to the PHY unit 31a. When receiving a pause-frame-release request signal from the logic gate unit 35, the MAC unit 32a generates a release frame and transmits the generated release frame to the PHY unit 31a.

The logic gate unit 35 receives a pause-frame request signal transmitted from the configuration controller 37, and transmits the received pause-frame request signal to the MAC unit 32a. In order to handle the normal operation state, which is other than a state where updating of configuration data in the FPGA unit 33 is performed, when receiving a pause-frame request signal from at least one of the configuration controller 37 or the flow controller 33b, the logic gate unit 35 transmits the received pause-frame request signal to the MAC unit 32a.

As in the case of a pause-frame request signal, the logic gate unit 35 performs a logical OR of pause-frame-release requests from the configuration controller 37 and the flow controller 33b. When receiving a pause-frame-release request signal from at least one of the configuration controller 37 or the flow controller 33b, the logic gate unit 35 transmits the pause-frame-release request signal to the MAC unit 32a.

In the case of updating configuration data of the FPGA unit 33, the configuration controller 37 transmits to the logic gate unit 35 a pause-frame request signal for temporarily stopping the transmission of data from the router 20. After transfer of the configuration data to the FPGA unit 33 is completed, the configuration controller 37 transmits to the logic gate unit 35 a pause-frame-release request signal for resuming the transmission of data from the router 20.

The processing of the data communication apparatus according to the second embodiment is described with reference to FIG. 5. The processing of the data communication apparatus according to the second embodiment is different from that of the data communication apparatus according to the first embodiment in the points described below.

That is, in the case of updating configuration data of the FPGA unit 33, the configuration controller 37 transmits to the logic gate unit 35 a pause-frame request signal for temporarily stopping the transmission of data from the router 20 (S301). The logic gate unit 35 receives the pause-frame request signal transmitted from the configuration controller 37 and transmits the received pause-frame request signal to the MAC unit 32a (S302). The MAC unit 32a receives the pause-frame request signal from the logic gate unit 35, generates a pause frame, and transmits the generated pause frame to the PHY unit 31a.

After transfer of the configuration data to the FPGA unit 33 is completed, the configuration controller 37 transmits to the logic gate unit 35 a pause-frame-release request signal for resuming the transmission of data from the router 20 (S308). The logic gate unit 35 receives the pause-frame-release request signal transmitted from the configuration controller 37, and transmits the received pause-frame-release request signal to the MAC unit 32a (S309). The MAC unit 32a receives the pause-frame-release request signal from the logic gate unit 35, generates a release frame, and transmits the generated release frame to the PHY unit 31a.

### Advantages of Second Embodiment

As described above, according to the second embodiment, a data communication apparatus includes a pause-frame generator (for example, the MAC unit 32a) that generates a pause frame for temporarily stopping the transmission of data from an external data communication apparatus (for example, the router 20) and a pause-frame transmitter (for example, the PHY unit 31a) that transmits the generated pause frame to the external data communication apparatus (for example, the router 20). In addition, a pause-frame request signal for requesting generation of a pause frame is generated as stop-control information and is transmitted to the pause-frame generator (for example, the MAC unit 32a). Thus, when full-duplex communication is performed between the data communication apparatus and the external data communication apparatus (for example, between the router 30 and the router 20), transmission of data from the external data communication apparatus (for example, the router 20) can be temporarily stopped while functions (a pause-frame request signal generation function and a pause-frame request signal transmission function) can be achieved. As in the case of half-duplex communication, when full-duplex communication is performed, even if transmission of data from the external data communication apparatus (for example, the router 20) is temporarily stopped, user data transmitted from an end user can be temporarily saved in the external data communication apparatus (for example, the buffer 21 of the router 20). Thus, configuration data can be updated without stopping a service to the end user.

### Third Embodiment

In the above-described embodiments, transmission of data is temporarily stopped by using a signal (a back-pressure request signal or a pause-frame request signal) used in a case where communication is performed between routers, and configuration data of the FPGA unit 33 is updated. However, the present invention is not limited to this. An optical transmission apparatus may be used as a data communication apparatus according to an embodiment. An outline and features of a data communication apparatus according to a third embodiment and a configuration and processing of the data communication apparatus according to the third embodiment is described in that order, and then advantages of the third embodiment is described. For example, a case where an optical transmission apparatus performs communication using a synchronous optical network/synchronous digital hierarchy (SONET/SDH) communication method is described.

Similarly to the data communication apparatuses according to the above-described embodiments, an outline of the data communication apparatus according to the third embodiment is that the data communication apparatus stores each data received via a network and transfers each data in accordance with destination addresses of each data in the order in which each data were stored. A main feature of the data communication apparatus according to the third embodiment is that the data communication apparatus is capable of updating configuration data of a programmable logic circuit without stopping a service to an end user by using data mapped in a frame format based on SONET/SDH.

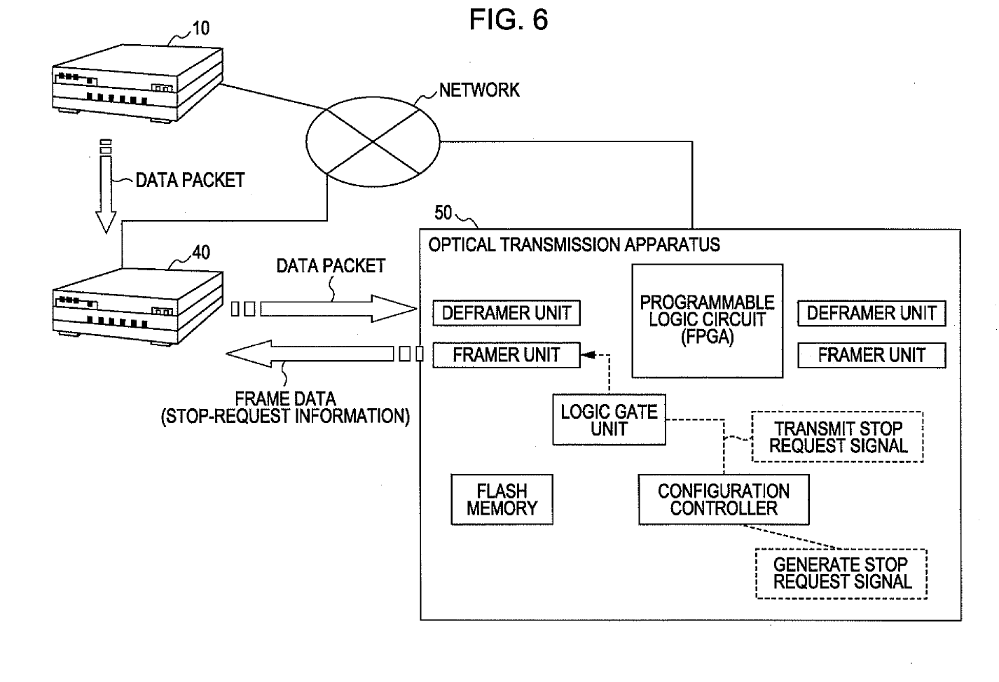

That is, as shown in FIG. 6, in the case of updating configuration data of a programmable logic circuit (FPGA), a configuration controller of an optical transmission apparatus 50 generates a stop-request signal for temporarily stopping the transmission of data (a data packet) from an optical transmission apparatus 40 and transmits the generated stop-request signal to a logic gate unit. The logic gate unit receives the stop-request signal transmitted from the configuration controller, and transmits the received stop-request signal to a FRAMER unit.

The FRAMER unit receives the stop-request signal from the configuration controller, and transmits information indicating a request for temporary stopping of data transmission, in an unlimiting example, the information being inserted in an unused area of a header portion of a frame format based on SONET/SDH, to the optical transmission apparatus 40.

The optical transmission apparatus 40 analyzes the data received from the optical transmission apparatus 50. If the information indicating the request for temporary stopping of data transmission is inserted in the header portion of the received data, the optical transmission apparatus 40 temporarily stops the transmission of data to the optical transmission apparatus 50. While transmission of data to the optical transmission apparatus 50 is temporarily stopped, the optical transmission apparatus 40 stores data transmitted from the host node 10 into a buffer contained in the optical transmission apparatus 40.

After transfer of the configuration data to the programmable logic circuit (FPGA) is completed, the configuration controller generates a stop-release request signal for resuming the transmission of data from the optical transmission apparatus 40 and transmits the generated stop-release request signal to the logic gate unit. The logic gate unit receives the stop-release request signal transmitted from the configuration controller, and transmits the received stop-release request signal to the FRAMER unit.

The FRAMER unit receives the stop-release request signal from the configuration controller, and transmits information indicating a request for release of the stopping of data transmission, the information being inserted in an unused area of a header portion of a frame format based on SONET/SDH, to the optical transmission apparatus 40.

The optical transmission apparatus 40 analyzes the data received from the optical transmission apparatus 50. If the information indicating the request for release of the stopping of data transmission is inserted in the header portion of the data, the optical transmission apparatus 40 resumes the transmission of data to the optical transmission apparatus 50. Since the other operations of the data communication apparatus according to the third embodiment are similar to those of the data communication apparatuses according to the above-described embodiments, the description of those operations is omitted.

Accordingly, the data communication apparatus according to the third embodiment is capable of updating configuration data of a programmable logic circuit without stopping a service to an end user by using data mapped in a frame format based on SONET/SDH.

### Configuration and Processing of Data Communication Apparatus

### Third Embodiment

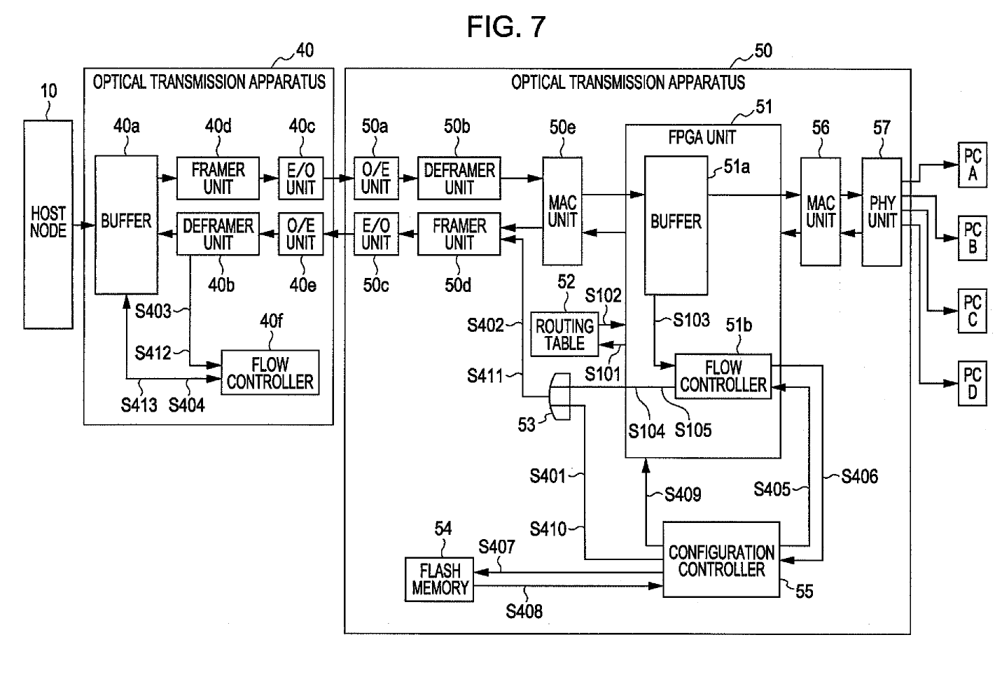

The configuration and processing of the data communication apparatus according to the third embodiment is described with reference to FIG. 7. FIG. 7 illustrates the configuration and processing of the data communication apparatus according to the third embodiment.

Basically, the data communication apparatus (optical transmission apparatus) according to the third embodiment has a configuration (processing functions) similar to that of the data communication apparatuses according to the above-described embodiments. However, the data communication apparatus according to the third embodiment is different from the data communication apparatuses according to the above-described embodiments in the points described below.

That is, the FRAMER unit shown in FIG. 7 performs data mapping using a SONET/SDH communication method. For example, when receiving a stop-request signal from a configuration controller 55, a FRAMER unit 50d of the optical transmission apparatus 50 inserts information indicating a request for temporary stopping of data transmission into an unused area of a header portion of a frame format based on SONET/SDH and transmits the information to the optical transmission apparatus 40 via an electrical/optical conversion (E/O) unit 50c.

Each E/O unit converts an electric signal into an optical signal. Each optical/electrical conversion (O/E) unit converts an optical signal into an electric signal.

A DEFRAMER unit performs data demapping using the SONET/SDH communication method. For example, a DEFRAMER unit 40b of the optical transmission apparatus 40 analyzes data received via an O/E unit 40e from the optical transmission apparatus 50. If it is determined that information indicating a request for temporary stopping of data transmission is inserted in a header portion of the received data, the DEFRAMER unit 40b requests a flow controller 40f to temporarily stop the transmission of data to the optical transmission apparatus 50, The flow controller 40f receives the request from the DEFRAMER unit 40b, and stops the transmission of data from a buffer 40a.

if it is determined in accordance with an analysis result of the data received via the O/E unit 40e from the optical transmission apparatus 50, that information indicating a request for release of the stopping of data transmission is inserted in a header portion of the received data, the DEFRAMER unit 40b requests the flow controller 40f to resume the transmission of data to the optical transmission apparatus 50. The flow controller 40f receives the request from the DEFRAMER unit 40b, and releases the stopping of the transmission of data from the buffer 40a.

In the case of updating configuration data of an FPGA unit 51 the configuration controller 55 of the optical transmission apparatus 50 generates a stop-request signal for temporarily stopping the transmission of data from the optical transmission apparatus 40 and transmits the generated stop-request signal to a logic gate unit 53. After transfer of the configuration data to the FPGA unit 51 is completed, the configuration controller 55 generates a stop-release request signal for resuming the transmission of data from the optical transmission apparatus 40 and transmits the generated stop-release request signal to the logic gate unit 53.

The logic gate unit 53 of the optical transmission apparatus 50 transmits to the FRAMER unit 50d a stop-request signal or a stop-release request signal received from the configuration controller 55. As in the above-described embodiments, in order to handle the normal operation state other than a state where updating of configuration data in the FPGA unit 51 is performed, when receiving a signal from at least one of the configuration controller 55 or a flow controller 51b, the logic gate unit 53 transmits the received signal to the FRAMER unit 50d.

The processing of the data communication apparatus according to the third embodiment is described with reference to FIG. 7. The processing of the data communication apparatus according to the third embodiment is different from the processing of the data communication apparatuses according to the above-described embodiments in the points described below.

That is, as shown in FIG. 7, in the case of updating configuration data of the FPGA unit 51, the configuration controller 55 of the optical transmission apparatus 50 generates a stop-request signal for temporarily stopping the transmission of data (a data packet) from the optical transmission apparatus 40 and transmits the generated stop-request signal to the logic gate unit 53 (S401). The logic gate unit 53 receives the stop-request signal transmitted from the configuration controller 55, and transmits the received stop-request signal to the FRAMER unit 50d (S402).

The FRAMER unit 50d receives the stop-request signal from the configuration controller 55, and transmits information indicating a request for temporary stopping of data transmission, the information being inserted in an unused area of a header portion of a frame format based on SONET/SDH, via the E/O unit 50c to the optical transmission apparatus 40.

The DEFRAMER unit 40b of the optical transmission apparatus 40 analyzes the data received via the O/E unit 40e from the optical transmission apparatus 50. If it is determined that information indicating a request for temporary stopping of data transmission is inserted in the header portion of the received data, the DEFRAMER unit 40b requests the flow controller 40f to temporarily stop the transmission of data to the optical transmission apparatus 50. The flow controller 40f receives the request from the DEFRAMER unit 40b, and stops the transmission of data from the buffer 40a (S403).

After transfer of the configuration data to the FPGA unit 51 is completed, the configuration controller 55 generates a stop-release request signal for resuming the transmission of data from the optical transmission apparatus 40 and transmits the generated stop-release request signal to the logic gate unit 53 (S410). The logic gate unit 53 receives the stop-release request signal transmitted from the configuration controller 55, and transmits the received stop-release request signal to the FRAMER unit 50d (S411).

The FRAMER unit 50d receives the stop-release request signal from the configuration controller 55, and transmits information indicating a request for release of the stopping of data transmission, the information being inserted in an unused area of a header portion of a frame format based on SONET/SDH, to the optical transmission apparatus 40.

The DEFRAMER unit 40b of the optical transmission apparatus 40 analyzes the data received from the optical transmission apparatus 50. If it is determined that information indicating a request for release of the stopping of data transmission is inserted in the header portion of the received data, the DEFRAMER unit 40b requests the flow controller 40f to resume the transmission of data to the optical transmission apparatus 50 (S412). The flow controller 40f receives the request from the DEFRAMER unit 40b, and releases the stopping of the transmission of data from the buffer 40a (S413).

### Advantages of Third Embodiment

As described above, according to the third embodiment, in order to temporarily stop the transmission of data from an external data communication apparatus (for example, the optical transmission apparatus 40), a data communication apparatus includes a frame-data generator that generates frame data including stop-request information indicating a request for stopping of data transmission, in an unlimiting example, the information being inserted in a header portion of the frame data, and a frame-data transmitter that transmits the frame data generated by the frame-data generator to the external data communication apparatus (for example, the optical transmission apparatus 40). In addition, a request signal for requesting transmission of the frame data is generated as stop-control information and is transmitted to the frame-data generator. Thus, in a case where the data communication apparatus and the external data communication apparatus are optical transmission apparatuses that perform communication using the SONET/SDH communication method, information for stopping data transmission can be inserted into an unused area of a header portion of a frame format based on SONET/SDH, and transmission of data from the external optical transmission apparatus can be temporarily stopped. In addition, as in the data communication apparatus that performs half-duplex communication or full-duplex communication, an optical transmission apparatus that performs communication using the SONET/SDH communication method is capable of temporarily saving user data transmitted from an end user into the external optical transmission apparatus (for example, a buffer of the external optical transmission apparatus) even if transmission of data from the external optical transmission apparatus is temporarily stopped. Thus, updating of configuration data of a programmable logic circuit can be achieved without topping a service to the end user.

### Fourth Embodiment

The data communication apparatus according to the first embodiment may further include a buffer for temporarily storing data to be transmitted to the programmable logic circuit (FPGA). Hereinafter, an outline and features of a data communication apparatus according to a fourth embodiment and a configuration and processing of the data communication apparatus according to the fourth embodiment is described in that order, and then advantages of the fourth embodiment is described. In the description of the data communication apparatus according to the fourth embodiment, for example, a case where communication is performed between routers is described.

Similarly to the data communication apparatus according to the first embodiment, an outline of the data communication apparatus according to the fourth embodiment is that the data communication apparatus stores each data received via a network and transfers each data in accordance with destination addresses of each data in the order in which each data were stored. A main feature of the data communication apparatus according to the fourth embodiment is that, with the provision of a buffer for temporarily storing data to be transmitted to a programmable logic circuit (FPGA), the data communication apparatus is capable of updating configuration data of the programmable logic circuit without stopping a service to an end user.

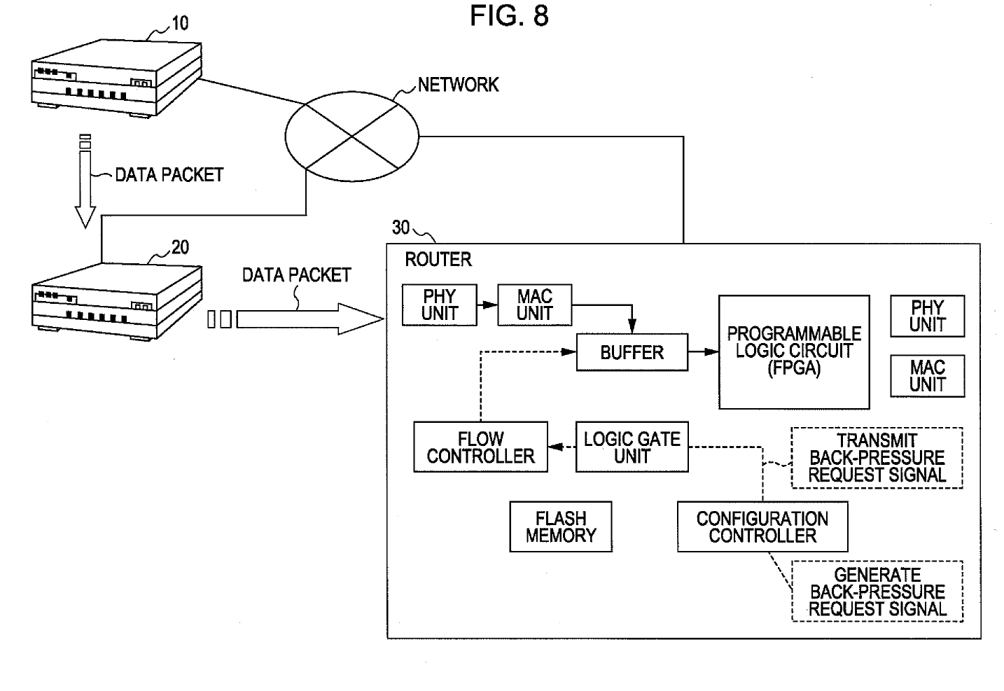

That is, as shown in FIG. 8, in the case of updating configuration data of the programmable logic circuit (FPGA), the configuration controller of the router 30 generates a back-pressure request signal for temporarily stopping the transmission of data (a data packet) from the buffer to the FPGA and transmits the generated back-pressure request signal to the logic gate unit. The logic gate unit receives the back-pressure request signal transmitted from the configuration controller, and transmits the received back-pressure request signal to a flow controller that controls the transmission of data from a buffer. The flow controller receives the back-pressure request signal from the logic gate unit, and stops the transmission of data from the buffer to the programmable logic circuit (FPGA).

After transfer of the configuration data is completed, the configuration controller of the router 30 transmits to the logic gate unit a back-pressure-release request signal for resuming the transmission of data from the buffer to the FPGA. The logic gate unit receives the back-pressure-release request signal transmitted from the configuration controller, and transmits the received back-pressure-release request signal to the flow controller. The flow controller receives the back-pressure-release request signal from the logic gate unit, and releases the stopping of the transmission of data from the buffer to the programmable logic circuit (FPGA). When receiving data from the host node 10, the router 20 continues normal data transmission to the router 30. Since the other operations of the data communication apparatus according to the fourth embodiment are similar to those of the data communication apparatus according to the first embodiment, the description of those operations is omitted.

Accordingly, with the provision of a buffer for temporarily storing data to be transmitted to a programmable logic circuit (FPGA), the data communication apparatus according to the fourth embodiment is capable of updating configuration data of the programmable logic circuit without stopping a service to an end user.

### Configuration and Processing of Data Communication Apparatus

### Fourth Embodiment

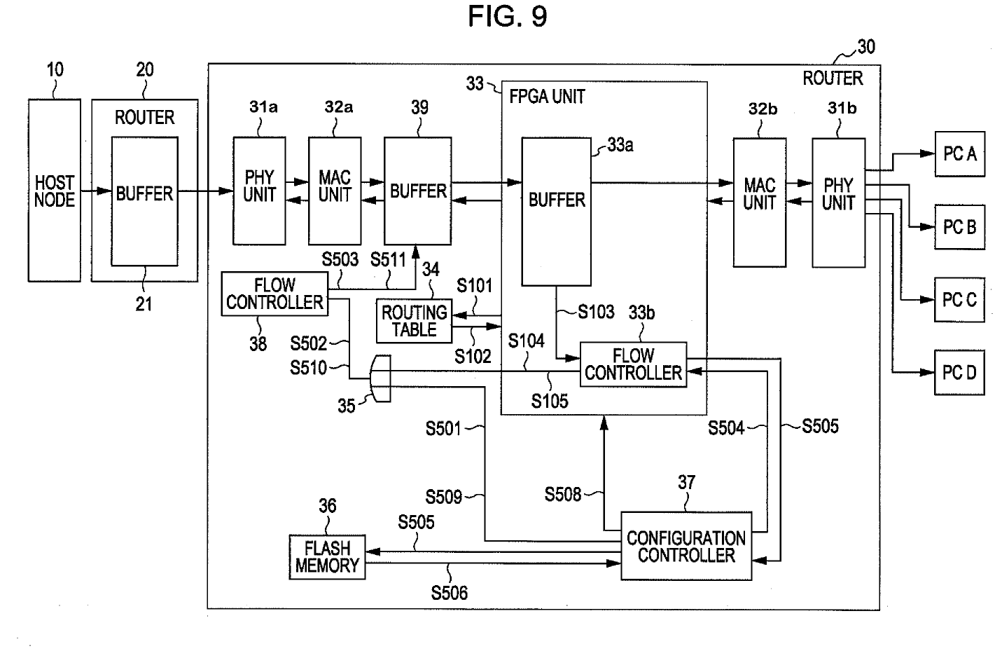

The configuration and processing of the data communication apparatus according to the fourth embodiment is described with reference to FIG. 9. FIG. 9 illustrates the configuration and processing of the data communication apparatus according to the fourth embodiment.

Basically, the data communication apparatus according to the fourth embodiment has a configuration (processing functions) similar to that of the data communication apparatus according to the first embodiment. However, the data communication apparatus according to the fourth embodiment is different from the data communication apparatus according to the first embodiment in the points described below.

That is, when receiving a back-pressure request signal transmitted from the configuration controller 37, the logic gate unit 35 of the router 30 transmits the received back-pressure request signal to the a flow controller 38 that controls the transmission of data from a buffer 39. When receiving a back-pressure-release request signal transmitted from the configuration controller 37, the logic gate unit 35 transmits the received back-pressure-release request signal to the flow controller 38.

When receiving a back-pressure request signal from the logic gate unit 35, the flow controller 38 stops the transmission of data from the buffer 39 to the FPGA unit 33. When receiving a back-pressure release request signal from the logic gate unit 35, the flow controller 38 releases the stopping of the transmission of data from the buffer 39 to the FPGA unit 33.

The processing of the data communication apparatus according to the fourth embodiment is described with reference to FIG. 9. The processing of the data communication apparatus according to the fourth embodiment is different from the processing of the data communication apparatus according to the first embodiment in the points described below.

That is, in the case of updating configuration data of the FPGA unit 331 the configuration controller 37 of the router 30 generates a back-pressure request signal for temporarily stopping the transmission of data (a data packet) from the router 20 by stopping transmission from buffer 39 and transmits the generated back-pressure request signal to the logic gate unit 35 (S501). The logic gate unit 35 receives the back-pressure request signal transmitted from the configuration controller 37, and transmits the received back-pressure request signal to the flow controller 38, which controls the transmission of data from the buffer 39 (S502). The flow controller 38 receives the back-pressure request signal from the logic gate unit 35, and stops the transmission of data from the buffer 39 to the FPGA unit 33 (S503).

After transfer of the configuration data is completed the configuration controller 37 of the router 30 transmits to the logic gate unit 35 a back-pressure-release request signal for resuming the transmission of data from the router 20 (S509). The logic gate unit 35 receives the back-pressure-release request signal transmitted from the configuration controller 37, and transmits the received back-pressure-release request signal to the flow controller 38 (S510). The flow controller 38 receives the back-pressure-release request signal from the logic gate unit 35, and releases the stopping of the transmission of data from the buffer 39 to the FPGA unit 33 (S511).

The above-described processing functions can be applied to a case where full-duplex communication using a pause-frame signal is performed as in the second embodiment and a case where communication is performed between optical transmission apparatuses as in the third embodiment as well as a case where half-duplex communication using a back-pressure request signal is performed as in the first embodiment.

### Advantages of Fourth Embodiment

As described above, according to the fourth embodiment, a data communication apparatus includes a second data storage unit (for example, the buffer 39) that stores data received from an external data communication apparatus (for example, the router 20) and that transmits data to a first data storage unit (for example, the buffer 33a) provided in a programmable logic circuit; and a data transmission controller (for example, the flow controller 38) that performs control such that transmission of data from the second data storage unit to the first data storage unit is temporarily stopped. In addition, a request signal for requesting temporary stopping of the transmission of data from the second data storage unit to the first data storage unit is generated as stop-control information and is transmitted to the data transmission controller. Thus, in a data communication apparatus that performs half-duplex communication or full-duplex communication or an optical transmission apparatus that performs communication using a SONET/SDH communication method, for example, a second buffer that stores user data in advance as well as a first buffer provided in an FPGA may be provided and transmission of the stored user data from the second buffer to the first buffer provided in the FPGA can be temporarily stopped. While transmission of data to the first buffer provided in the FPGA is stopped, data can be temporarily stored in the second buffer. Thus, configuration data can be updated without stopping a service to an end user.

### Fifth Embodiment

The first to forth embodiments have been described above. However, the present invention is not limited to any of the above-described embodiments. Various changes and modifications can be made to the present invention. Other embodiments is described below.

(1) Pull-Up of Output Pin

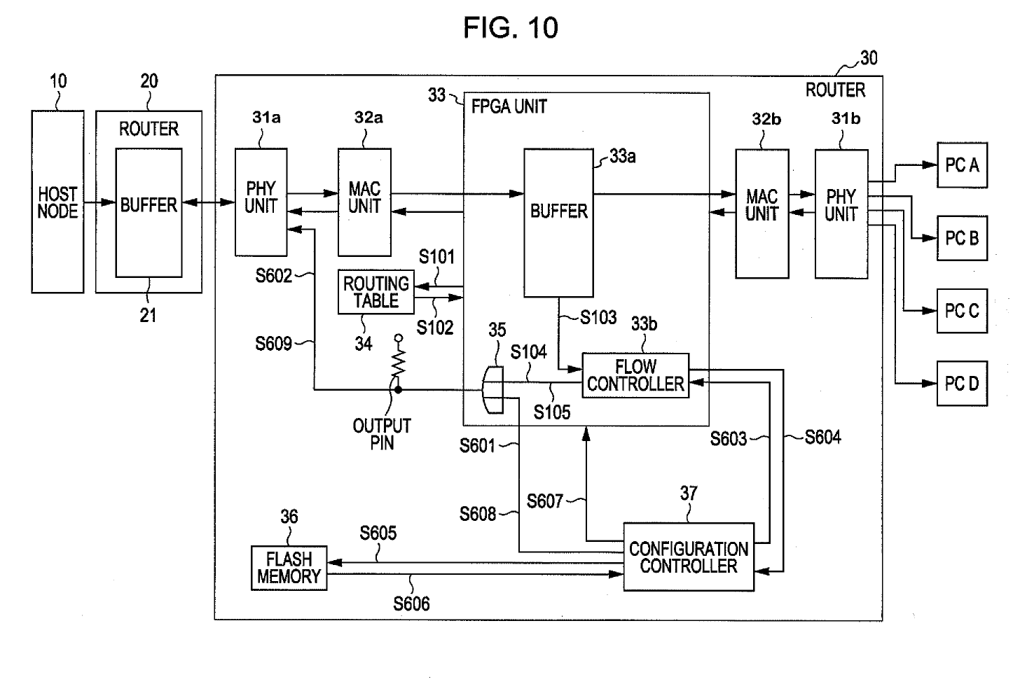

In the above-described embodiments, even if the output of a signal transmitted from the configuration controller is not constant, the effectiveness of the signal may be maintained by pulling up an output pin. For example, as shown in FIG. 10, the logic gate unit 35 receives a back-pressure request signal (S601) or a back-pressure-release request signal (S608) transmitted from the configuration controller 37. Then, the logic gate unit 35 pulls up an output pin to which each signal is transmitted from the logic gate unit 35.

Accordingly, the transmission output of a back-pressure request, which is stop-control information, is maintained. Thus, for example, even if the output of stop-control information transmitted from the FPGA through the flow controller 33b might not be constant during updating of configuration data, the effectiveness of the stop-control information can be maintained. Thus, updating of configuration data can be reliably achieved.

(2) Saving and Restoring of Prior Information

In the above-described embodiments, before updating of configuration data of the programmable logic circuit (FPGA) is performed, prior information relating to communication stored in advance in the programmable logic circuit (FPGA) (for example, pre-set information relating to communication, such as the speed of data communication between apparatuses) may be saved. After the updating is completed, the saved prior information may be restored.

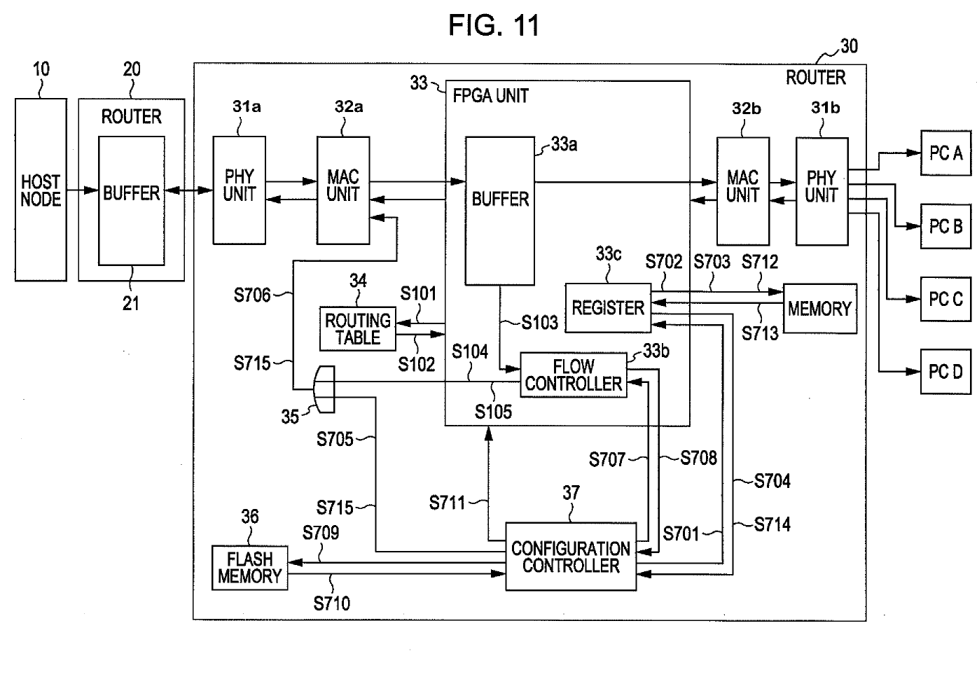

Referring to FIG. 11, before updating of configuration data of the programmable logic circuit (FPGA) is performed, the configuration controller 37 transmits an update start request to a register 33c (S701). The register 33c receives the update start request from the configuration controller 371 transmits a write request (S702), and stores stored prior information into a memory (S703). Then, the register 33c transmits to the configuration controller 37 notification indicating that storing of the prior information has been completed (S704). The configuration controller 37 receives the notification from the register 33c, and starts updating.

After updating is completed, the register 33c transmits a read request (S712). Then, the register 33c stores the prior information read from the memory (S713).

As described above, before updating of configuration data of the programmable logic circuit (FPGA) is performed, prior information relating to communication between data communication apparatuses, the prior information being stored in the register 33c provided in the programmable logic circuit, is saved. After updating of the configuration data is completed, the saved prior information is restored. Thus, even in a case where updating of configuration data is performed, it is unnecessary to set again prior information relating to communication between data communication apparatuses (for example, pre-set information relating to communication, such as the speed of data communication between apparatuses) and the prior information can be easily restored and can be used again.

(3) Configuration of Apparatus Etc.

Components of the routers shown in FIGS. 3, 5, 9, 10, and 11, which are data communication apparatuses, and the optical transmission apparatus shown in FIG. 7, which is a data communication apparatus, are illustrated in view of functional concepts, and these components may not be physically configured as illustrated. That is, a specific configuration relating to distribution and integration of each of the apparatuses is not limited to any of the illustrations. Depending on the load or use condition, all or part of an apparatus may be distributed or integrated functionally or physically in desired units. For example, the configuration controller shown in each of the figures may be separated from the data communication apparatus. In addition, all or a desired part of each processing function performed by the data communication apparatus shown in each of the figures (each of the signal generation function, the signal transmission function, and the configuration data setting function, see FIGS. 3, 5, 7, 9, 10, and 11) may be achieved by a central processing unit (CPU) or a program that is analyzed and performed by the CPU or may be realized as hardware by wired logic.

(4) Configuration Information Update Program

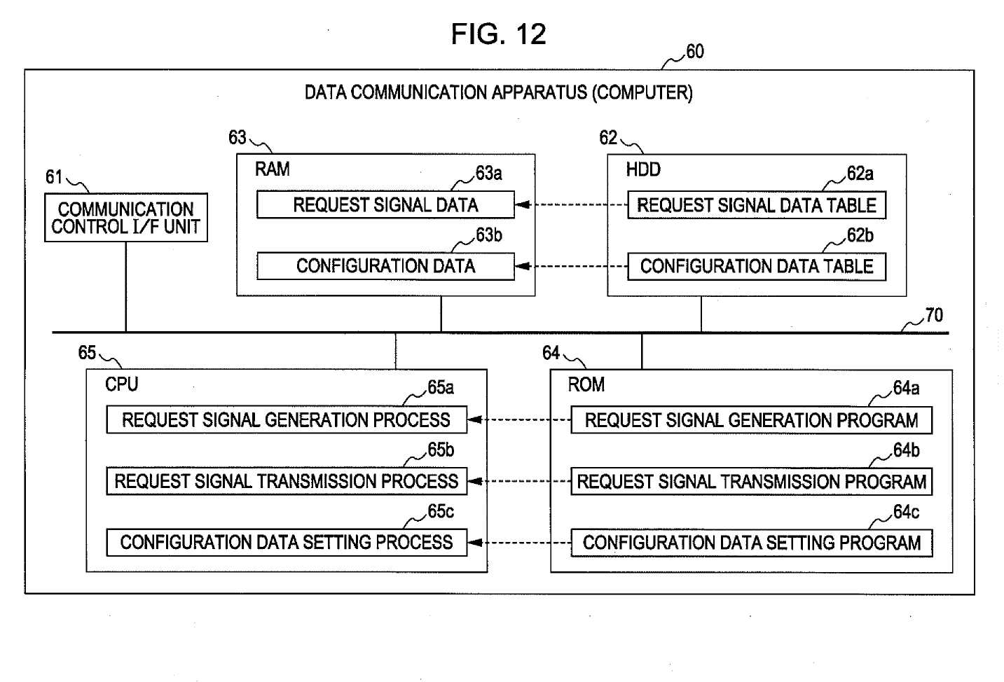

Various types of processing relating to the data communication apparatuses according to the above-described embodiments (for example, see FIGS. 3, 5, 7, 9, 10, and 11) can be achieved when a computer system, such as personal computer or a workstation, performs (executes) a program prepared in advance. Hereinafter, for example, a computer that performs a (executes) configuration information update program having functions similar to those of the data communication apparatuses according to the above-described embodiments is described. FIG. 12 illustrates a computer that performs (executes) a configuration information update program, according to an embodiment.

As shown in FIG. 12, in a computer 60, which is a data communication apparatus, a communication control I/F unit 61, a hard disk drive (HDD) 62, a random-access memory (RAM) 63, a read-only memory (ROM), 64 and a CPU 65 are connected to each other via a bus 70.

A data communication program that implements functions similar to those of the data communication apparatuses according to the above-described embodiments, that is, a request signal generation program 64a, a request signal transmission program 64b, and a configuration data setting program 64c are stored in advance in the ROM 64, as shown in FIG. 12. Similarly to the components of the data communication apparatuses shown in FIGS. 3, 5, 7, 9, 10, and 11, the programs 64a, 64b, and 64c may be integrated or distributed according to need. The ROM 64 may be a nonvolatile RAM.

When the CPU 65 reads the programs 64a, 64b, and 64c from the ROM 64 and performs (executes) the programs 64a, 64b, and 64c, the programs 64a, 64b, and 64c function as a request signal generation process 65a, a request signal transmission process 65b, and a configuration data setting process 65c, respectively, as shown in FIG. 12.

In addition, as shown in FIG. 12, the HDD 62 contains a request signal data table 62a and a configuration data table 62b. The CPU 65 reads request signal data 63a and configuration data 63b from the request signal data table 62a and the configuration data table 62b, respectively, and stores the request signal data 63a and the configuration data 63b into the RAM 63. Then, the CPU 65 performs processing in accordance with the request signal data 63a and the configuration data 63b stored in the RAM 63.

Each of the programs 64a, 64b, and 64c is not necessarily stored in the ROM 64 from the beginning. For example, each of the programs 64a, 64b, and 64c may be stored in a “portable physical medium”, such as a flexible disk (FD), a compact disc read-only memory (CD-ROM), a digital versatile disc (DVD), a magneto-optical disk, or an IC card, a “fixed physical medium”, such as an HDD provided inside or outside the computer 60, or an “external computer (or server)” connected to the computer 60 via a public line, the Internet, a local-area network (LAN), or a wide-area network (WAN). Then, the computer 60 may read and execute each of the programs 64a, 64b, and 64c.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A data communication apparatus storing each data received via a network from an external data communication apparatus and transferring each stored data, comprising:
a programmable logical circuit including configuration information; and
a stop-control information generator generating stop-control information stopping data transmitted from the external data communication apparatus from entering the programmable logic circuit, upon updating the circuit configuration information of the programmable logic circuit.

2. The data communication apparatus according to claim 1, further comprising:
a collision-signal transmitter transmitting to the external data communication apparatus a collision signal temporarily stopping transmission of data from the external data communication apparatus,
wherein the stop-control information generator generates, as the stop-control information, a request signal requesting transmission of the collision signal, and transmits the generated request signal to the collision-signal transmitter.

3. The data communication apparatus according to claim 1, further comprising:
a stop-frame generator generating a stop frame temporarily stopping transmission of the data from the external data communication apparatus; and
a stop-frame transmitter transmitting to the external data communication apparatus the stop frame generated by the stop-frame generator,
wherein the stop-control information generator generates, as the stop-control information, a request signal requesting generation of the stop frame, and transmits the generated request signal to the stop-frame generator.

4. The data communication apparatus according to claim 1, further comprising:
a frame-data generator generating frame data including stop-request information requesting temporary stopping of data transmission from the external data communication apparatus, the stop-request information inserted in a header portion of the frame data; and
a frame-data transmitter transmitting to the external data communication apparatus the frame data generated by the frame-data generator,
wherein the stop-control information generator generates, as the stop-control information, a request signal requesting transmission of the frame data including the stop-request information, and transmits the generated request signal to the frame-data generator.

5. The data communication apparatus according to claim 1, wherein the programmable logic circuit includes a first data storage, and the data communication apparatus further comprises:
a second data storage storing data received from the external data communication apparatus and transmitting the data to the first data storage in the programmable logic circuit; and
a data transmission controller temporarily stopping transmission of the data from the second data storage to the first data storage in the programmable logic circuit,
wherein the stop-control information generator generates, as the stop-control information, a request signal requesting the temporary stopping of transmission of data from the second data storage to the first data storage unit in the programmable logic circuit, and transmits the generated request signal to the data transmission controller.

6. The data communication apparatus according to claim 1, further comprising a transmission maintainer maintaining a transmission output of the stop-control information generated and transmitted by the stop-control information generator.

7. The data communication apparatus according to claim 1, further comprising:
a saver saving pre-set information stored in a memory of the programmable logic circuit and relating to data communication between the data communication apparatus and the external data communication apparatus, before the updating of the circuit configuration information of the programmable logic circuit; and
a restorer restoring the pre-set information saved by the saver, after the updating of the circuit configuration information of the programmable logic circuit.

8. A method of updating configuration information of a programmable logic circuit provided in a data communication apparatus that stores data received via a network from an external data communication apparatus and that transfers the stored data, comprising:
upon updating of the circuit configuration information of the programmable logic circuit, generating stop-control information stopping data transmitted from an external data communication apparatus from entering the programmable logic circuit.

9. A computer-readable recording medium recording a configuration information update program for controlling a computer to update circuit configuration information of a programmable logic circuit provided in a data communication apparatus that stores each data received via a network from an external data communication apparatus and that transfers each stored data, according to operations comprising:
upon updating of the circuit configuration information of the programmable logic circuit, generating stop-control information stopping data transmitted from an external data communication apparatus from entering the programmable logic circuit.
